(19) United States
(12) Patent Application Publication
(10) Pub. No.: US 2025/0048130 A1
(43) Pub. Date: Feb. 6, 2025

(54) BEAM INFORMATION TRANSMISSION AND RECEPTION METHODS AND APPARATUSES THEREFOR, AND COMMUNICATION SYSTEM

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 18/924,888

(22) Filed: Oct. 23, 2024

Related U.S. Application Data
(63) Continuation of application No. PCT/CN2022/090024, filed on Apr. 28, 2022.

(51) Int. Cl. H04W 16/28; H04W 72/21; H04W 72/231

(52) U.S. Cl. CPC H04W 16/28; H04W 72/21; H04W 72/231

(57) ABSTRACT

A beam information transmission apparatus, applicable to a network device, includes: a first receiver receives first request information. The first request information being used to indicate the network device to transmit at least the number and/or pattern parameter information of downlink transmitted beams and/or the number and/or pattern parameter information of uplink received beams; and a first transmitter transmits at least the number and/or pattern parameter information of the downlink transmitted beams, and/or the number and pattern parameter information of uplink received beams.

### CROSS-REFERENCE TO RELATED APPLICATION

This application is a continuation application of International Application PCT/CN2022/090024 filed on Apr. 28, 2022, and designated the U.S., the entire contents of which are incorporated herein by reference.

### FIELD

The embodiments of the present disclosure relate to the field of communication technologies.

### BACKGROUND

As low frequency band spectrum resources become scarce, a millimeter-wave frequency band may provide a greater bandwidth and becomes an important frequency band for a 5G NR (New Radio) system. Millimeter wave, due to its shorter wavelength, has different propagation characteristics from traditional low frequency bands such as a higher propagation loss, poor performance with reflection and diffraction. Therefore, a massive antenna array is usually used to form a shaped beam with a greater gain, overcome propagation losses and ensure system coverage. The 5G NR standard designs a series of schemes for beam management, such as beam sweeping, beam measurement, beam reporting, and beam indication. However, when the number of transmitting and receiving beams is relatively large, the load and latency of a system is greatly increased.

With the development of Artificial Intelligence (AI) technology, it has become a promising direction to apply the Artificial Intelligence technology to a physical layer of wireless communication to solve the difficulties of traditional methods. For beam management, using an AI model to predict a spatially optimal beam pair according to measurement results of a small number of beams may greatly reduce the load and latency of the system.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

It is assumed that a transmitter of a communication system has M beams and a receiver thereof has N beams. In the existing standards, M*N beams need to be measured. When the number of M and N is large, measuring the M*N beams leads to a larger system load and longer latency. Using a model (e.g., an AI model) to predict an optimal beam from measurement results of a small number of beams may greatly reduce the system load and latency caused by beam measurements. In the case of using the AI model to predict an optimal beam, it is necessary to know the number of beams at the transmitter, the number of beams at the receiver, and a pattern of the beams.

The inventor of the present disclosure finds that in the case of predicting an optimal beam according to a model (such as an AI model), a network device or a terminal equipment provided with the model does not know all information such as the number of beams at the transmitter, the number of beams at the receiver, and the pattern of the beams, thus it is difficult to obtain an appropriate model for predicting an optimal beam.

For example, for a downlink channel, if a model is provided at a network device side, the network device knows information on transmitted beams, but does not know information on received beams; if an AI model is provided at a terminal equipment side, the terminal equipment knows information on received beams, but does not know information on transmitted beams.

For another example, for an uplink channel, if a model is provided at a network device side, the network device knows information on received beams, but does not know information on transmitted beams; if an AI model is provided at a terminal equipment side, the terminal equipment knows information on transmitted beams, but does not know information on received beams.

For the above problems, the embodiments of the present disclosure provide beam information transmission and reception methods and apparatuses therefor, and a communication system; a network device or a terminal equipment receives relevant information on transmitted beams and/or received beams, whereby an appropriate model for predicting an optimal beam may be obtained.

According to one aspect of the embodiments of the present disclosure, a beam information transmission apparatus is provided, applicable to a network device, the apparatus including:
a first receiver at least receives the first request information. The first request information being used to indicate the network device to transmit at least the number and/or pattern parameter information of downlink transmitted beams, and/or the number and/or pattern parameter information of uplink received beams; and
a first transmitter transmits at least the number and/or pattern parameter information of the downlink transmitted beams, and/or the number and/or pattern parameter information of uplink received beams.

According to another aspect of the embodiments of the present disclosure, a beam information transmission apparatus is provided, applicable to a terminal equipment, the apparatus including:
a second receiver receives the second request information. The second request information being used to indicate the terminal equipment to transmit at least the number and/or pattern parameter information of downlink received beams, and/or the number and/or or pattern parameter information of uplink transmitted beams; and
a second transmitter transmits at least the number and/or pattern parameter information of the downlink received beams, and/or the number and/or pattern parameter information of the uplink transmitted beams.

According to another aspect of the embodiments of the present disclosure, a beam information reception apparatus is provided, applicable to a terminal equipment, the apparatus including:
a third transmitter transmits first request information. The first request information being used to indicate a network device to transmit at least the number and/or pattern parameter information of downlink transmitted beams, and/or the number and/or pattern parameter information of uplink received beams; and
a third receiver receives at least the number and/or pattern parameter information of the downlink transmitted beams, and/or the number and/or pattern parameter information of the uplink received beams.

According to another aspect of the embodiments of the present disclosure, a beam information reception apparatus is provided, applicable to a network device, the apparatus including:
a fourth transmitter transmits second request information. The second request information being used to indicate a terminal equipment to transmit at least the number and/or pattern parameter information of downlink received beams, and/or the number and/or pattern parameter information of uplink transmitted beams; and
a fourth receiver receives at least the number and/or pattern parameter information of the downlink received beams, and/or the number and/or pattern parameter information of the uplink transmitted beams.

One of the advantageous effects of the embodiments of the present disclosure is: a network device or a terminal equipment receives the number and/or pattern parameter information of transmitted beams and/or received beams, whereby an appropriate model for predicting an optimal beam may be obtained.

Referring to the later description and drawings, specific implementations of the present disclosure are disclosed in detail, indicating a manner that the principle of the present disclosure can be adopted. It should be understood that the implementations of the present disclosure are not limited in terms of the scope. Within the scope of the spirit and terms of the appended claims, the implementations of the present disclosure include many changes, modifications and equivalents.

Features that are described and/or shown with respect to one implementation can be used in the same way or in a similar way in one or more other implementations, can be combined with or replace features in the other implementations.

It should be emphasized that the term “comprise/include” when being used herein refers to the presence of a feature, a whole piece, a step or a component, but does not exclude the presence or addition of one or more other features, whole pieces, steps or components.

### BRIEF DESCRIPTION OF DRAWINGS

An element and a feature described in a drawing or an implementation of the present embodiments of the present disclosure can be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system of the present disclosure;

FIG. 2 is a schematic diagram of transmitted beams and received beams in a communication system of each embodiment of the present disclosure;

FIG. 3 is a schematic diagram of a beam information transmission method in the embodiments of a first aspect of the present disclosure;

FIG. 4 is a schematic diagram of a pattern of downlink transmitted beams;

FIG. 5 is a schematic diagram of a pattern of uplink received beams;

FIG. 6 is a schematic diagram of a beam information transmission method in the embodiments of a second aspect of the present disclosure;

FIG. 7 is a schematic diagram of a beam information reception method in the embodiments of a third aspect of the present disclosure;

FIG. 8 is a flow schematic diagram in which a communication system of the present disclosure performs communication according to a beam information transmission method of the first aspect and a beam information reception method of the third aspect;

FIG. 9 is a schematic diagram of a model for predicting an optimal beam;

FIG. 10 is a schematic diagram of a beam information reception method in the embodiments of a fourth aspect of the present disclosure;

FIG. 11 is a flow schematic diagram in which a communication system of the present disclosure performs communication according to a beam information transmission method of the second aspect and a beam information reception method of the fourth aspect;

FIG. 12 is a schematic diagram of a beam information transmission apparatus in the embodiments of a fifth aspect;

FIG. 13 is a schematic diagram of a beam information transmission apparatus in the embodiments of a sixth aspect;

FIG. 14 is a schematic diagram of a beam information reception apparatus in the embodiments of a seventh aspect;

FIG. 15 is a schematic diagram of a beam information reception apparatus in the embodiments of an eighth aspect;

FIG. 16 is a schematic diagram of a terminal equipment in the embodiments of a ninth aspect; and

FIG. 17 is a schematic diagram of a network device in the embodiments of a ninth aspect.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which can adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as New Radio (NR), Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: an Integrated Access and Backhaul node (IAB-node), a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.). And the term “BS” may include their some or all functions, each BS may provide communication coverage to a specific geographic region. The term “a cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above.

In the following description, without causing confusion, the terms “uplink control signal” and “Uplink Control Information (UCI)” or “Physical Uplink Control Channel (PUCCH)” are replaced mutually, and the terms “uplink data signal” and “uplink data information” or “Physical Uplink Shared Channel (PUSCH)” are replaced mutually.

The terms “downlink control signal” and “Downlink Control Information (DCI)” or “Physical Downlink Control Channel (PDCCH)” are replaced mutually, and the terms “downlink data signal” and “downlink data information” or “Physical Downlink Shared Channel (PDSCH)” are replaced mutually.

Moreover, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH; an uplink signal may include an uplink data signal and/or an uplink control signal, etc., or may also be referred to as UL transmission or uplink information or uplink channel. Transmitting an uplink transmission on an uplink resource may be understood as transmitting the uplink transmission by using the uplink resource. Similarly, downlink data/signals/channels/information may be understood accordingly.

In the embodiments of the present disclosure, higher-layer signaling may be e.g. radio resource control (RRC) signaling; for example, is called an RRC message, for example includes an MIB, system information, and a dedicated RRC message; or is called an RRC information element (RRC IE). The higher-layer signaling, for example, may further be Medium Access Control (MAC) signaling; or called a MAC control element (MAC CE). However, the present disclosure is not limited to these.

The scenarios of the embodiments of the present disclosure are described through the following examples, however the present disclosure is not limited to these.

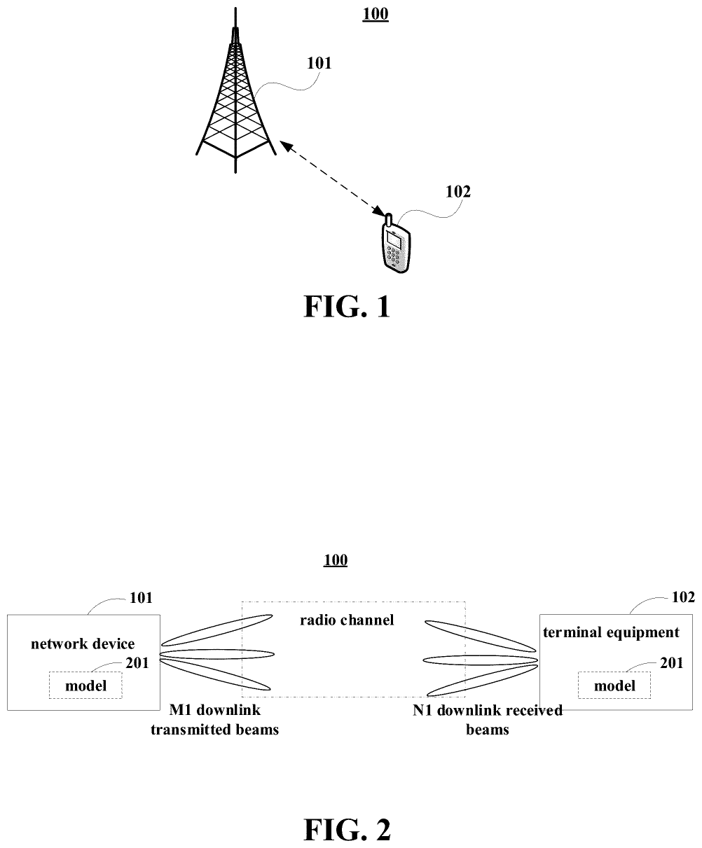

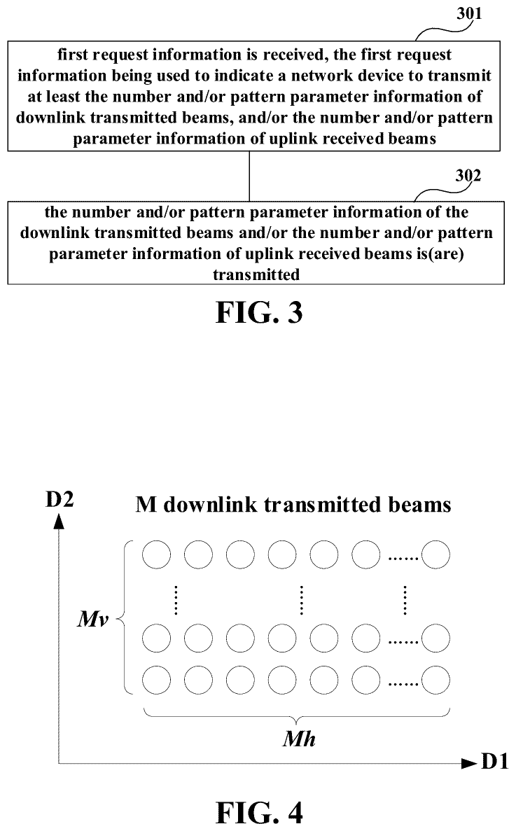

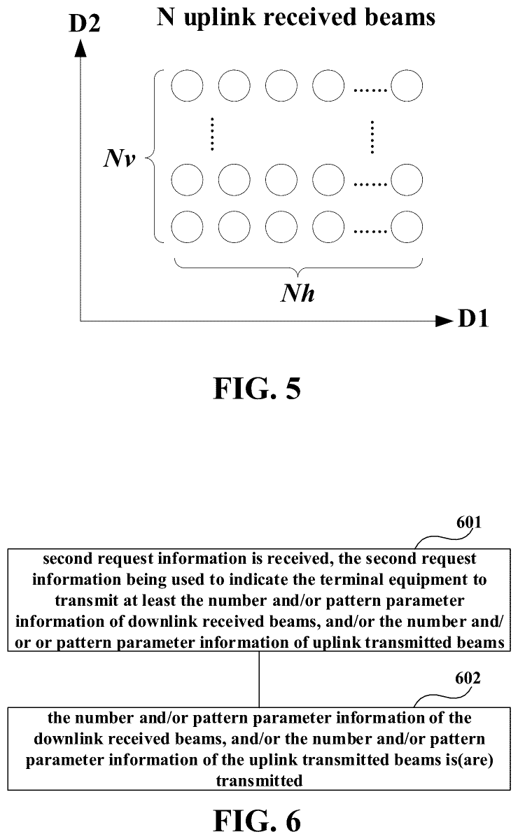

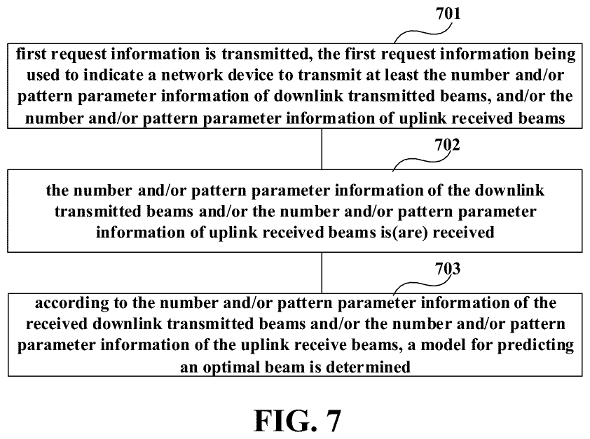

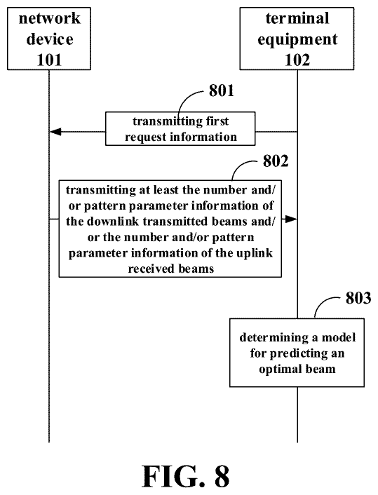

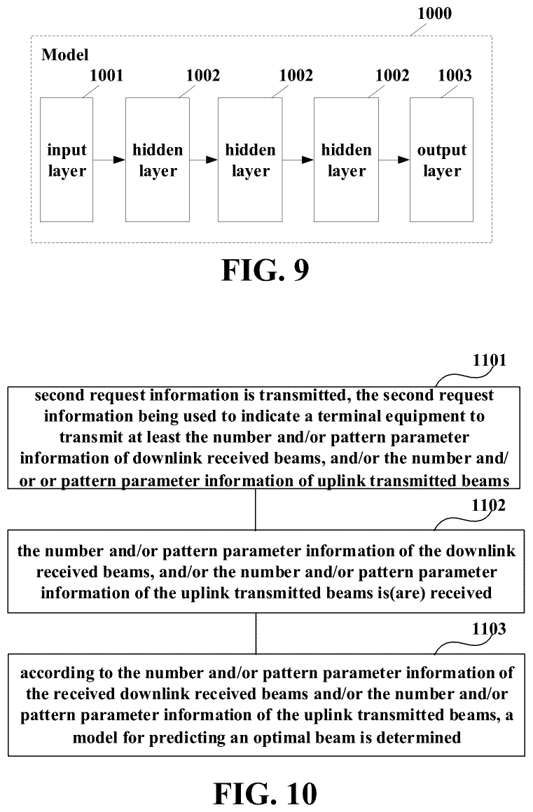

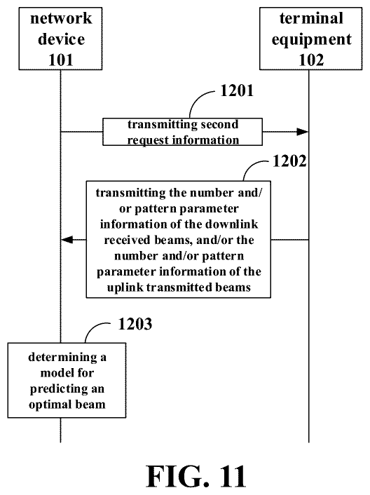

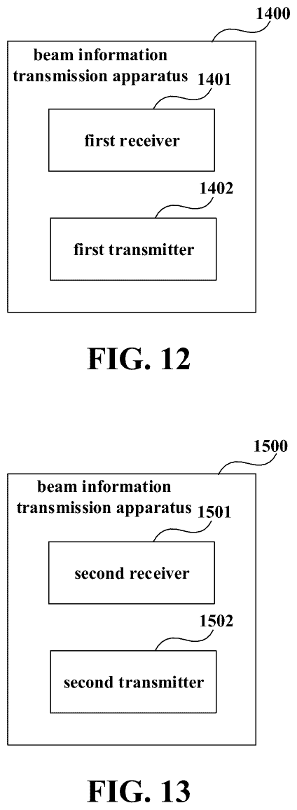

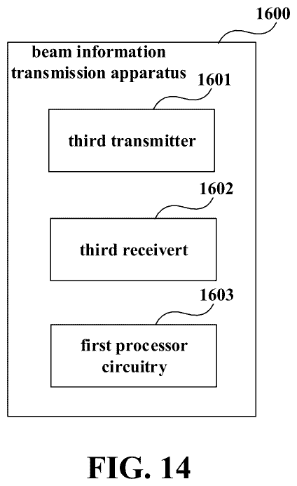

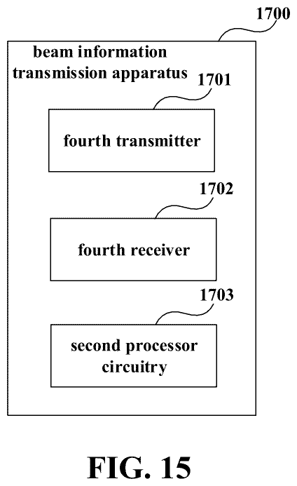

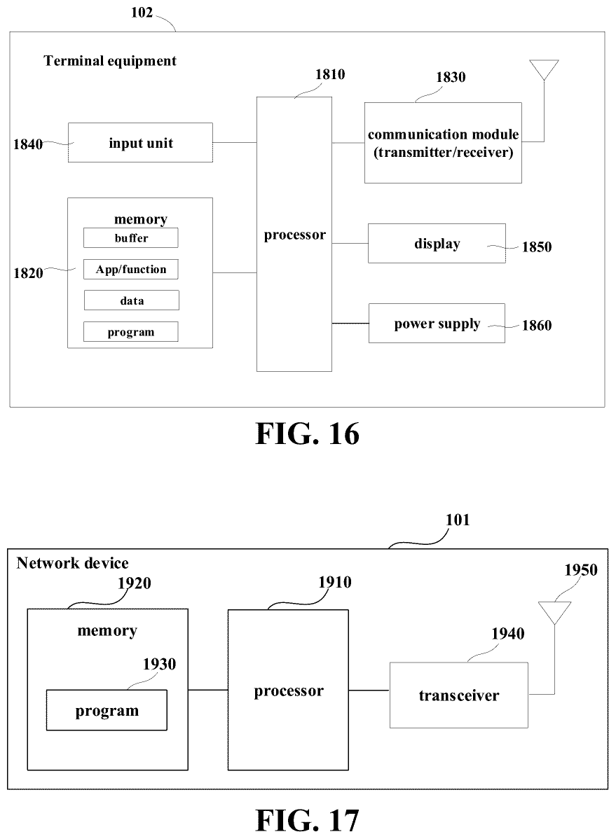

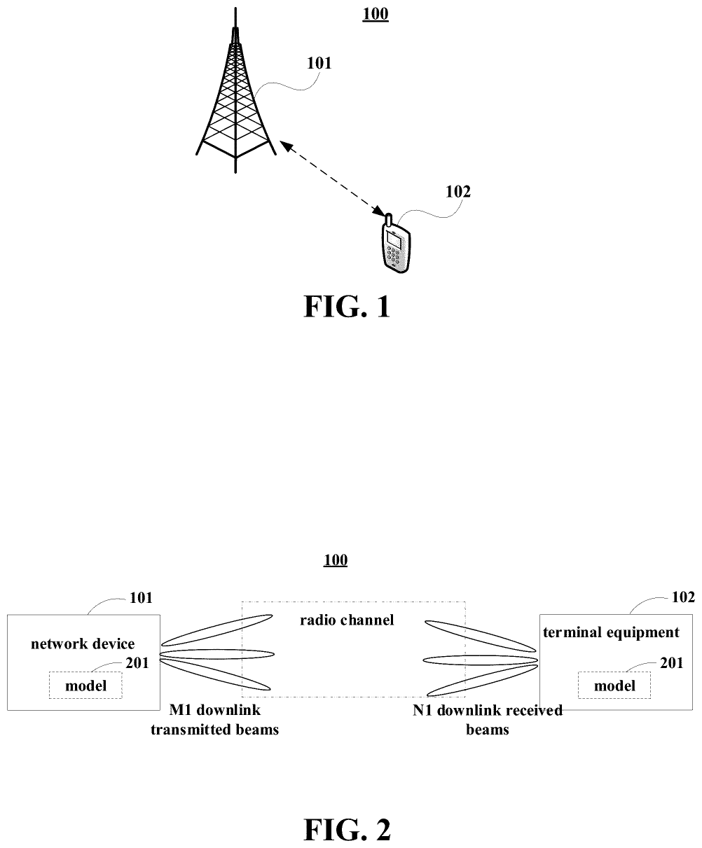

FIG. 1 is a schematic diagram of a communication system in the present disclosure, schematically shows a case by taking a terminal equipment and a network device as examples. As shown in FIG. 1, a communication system 100 may include a network device 101 and a terminal equipment 102 (for the sake of simplicity, an example having only one terminal equipment is schematically given in FIG. 1).

In the embodiments of the present disclosure, existing or further implementable services may be carried out between the network device 101 and the terminal equipment 102. For example, these services include but are not limited to: enhanced Mobile Broadband (eMBB), massive Machine Type Communication (mMTC), and Ultra-Reliable and Low-Latency Communication (URLLC).

The terminal equipment 102 may transmit data to the network device 101, for example, using an authorized or unauthorized transmission mode. The network device 101 may receive the data transmitted by one or more terminal equipments 102, and feed back information to the terminal equipment(s) 102, such as acknowledgment ACK information/non-acknowledgment NACK information, and the terminal equipment(s) 102 may confirm ending a transmission process, or may further perform new data transmission, or may perform data retransmission, according to the feedback information.

FIG. 2 is a schematic diagram of transmitted beams and received beams in a communication system of each embodiment of the present disclosure. As shown in FIG. 2, in the communication system 100, by taking a downlink channel as an example, the network device 101 may have M1 downlink transmitted beams, and the terminal device 102 may have N1 downlink received beams.

As shown in FIG. 2, a model 201 for predicting an optimal beam may be deployed in the network device 101 and/or the terminal equipment(s) 102. The model 201 may predict an optimal beam of M1*N1 beams according to measurement results of partial beams. The model 201 e.g. may be an AI model.

In addition, for an uplink channel, the network device 101 may have N2 uplink received beams (not shown in FIG. 2), and the terminal equipment(s) 102 may have M2 uplink transmitted beams (not shown in FIG. 2).

### Embodiments of a First Aspect

Embodiments of a first aspect provide a beam information transmission method, applicable to a network device, such as the network device 101 in FIG. 1 or FIG. 2.

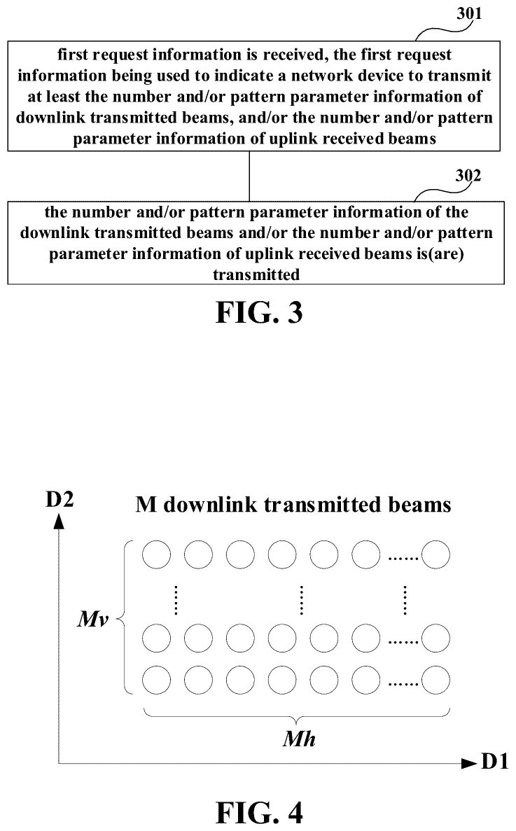

FIG. 3 is a schematic diagram of a beam information transmission method in the embodiments of a first aspect of the present disclosure, as shown in FIG. 3, the method includes:
operation 301, first request information is received, the first request information being used to indicate the network device to transmit at least the number and/or pattern parameter information of downlink transmitted beams, and/or the number and/or pattern parameter information of uplink received beams; and
operation 302, the number and/or pattern parameter information of the downlink transmitted beams and/or the number and/or pattern parameter information of uplink received beams is(are) transmitted.

In the operation 301, the first request information is for example carried in a Beam InformEquiry message.

In the operation 302, in response to the received first request information, the network device 101 may transmit to the terminal equipment 102 at least the number and/or pattern parameter information of the downlink transmitted beams and/or the number and/or pattern parameter information of uplink received beams. For example, for a downlink channel, the network device 101 may transmit to the terminal equipment 102 at least the number and/or pattern parameter information of the downlink transmitted beams; for an uplink channel, the network device 101 may transmit to the terminal equipment 102 at least the number and/or pattern parameter information of uplink received beams.

In as least one embodiment in the operation 302, the number and/or pattern parameter information of the downlink transmitted beams and/or the number and/or pattern parameter information of uplink received beams may be carried in a BeamInformResponse message.

In as least one embodiment in the operation 302, the network device 101 may transmit at least the number and/or pattern parameter information of the downlink transmitted beams and/or the number and/or pattern parameter information of uplink received beams via at least one of Radio Resource Control (RRC) signaling, Media Access Control Control Element (MAC CE) or Downlink Control Information (DCI).

Through the embodiments of the first aspect, the network device 101 transmits to the terminal equipment 102 at least the number and/or pattern parameter information of the downlink transmitted beams and/or the number and/or pattern parameter information of the uplink received beams, whereby the terminal equipment 102 is capable of training or selecting an appropriate model according to the number and/or pattern parameter information of the received downlink transmitted beams and/or the number and/or pattern parameter information of the received uplink received beams, so as to predict an optimal beam by using the model.

The pattern parameter information of the downlink transmitted beams at least includes the number of beams of the downlink transmitted beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

FIG. 4 is a schematic diagram of a pattern of downlink transmitted beams. As shown in FIG. 4, the number of the downlink transmitted beams is M, the M downlink transmitted beams are configured in an array, wherein there are Mh columns of the downlink transmitted beams in a first dimension D1, and Mv rows of the downlink transmitted beams in a second dimension D2.

The above description of the patterns of the downlink transmitted beams also applies to the description of the patterns of the uplink transmitted beams.

The pattern parameter information of the uplink received beams at least includes the number of beams of the uplink received beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

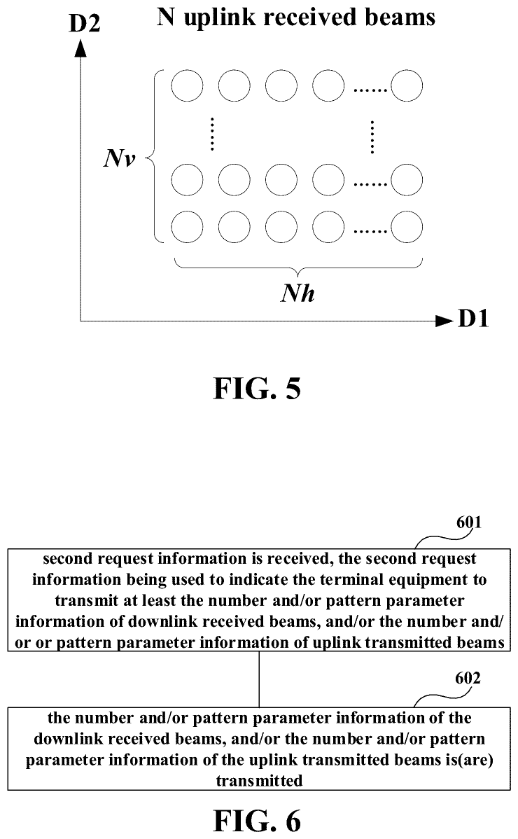

FIG. 5 is a schematic diagram of a pattern of uplink received beams. As shown in FIG. 5, the number of the uplink received beams is N, the N uplink received beams are configured in an array, wherein there are Nh columns of the uplink received beams in a first dimension D1, and Nv rows of the uplink received beams in a second dimension D2.

The above description of the patterns of the uplink received beams also applies to the description of the patterns of the downlink received beams.

### Embodiments of a Second Aspect

Embodiments of a second aspect provide a beam information transmission method, applicable to a terminal equipment, such as the terminal equipment 102 in FIG. 1 or FIG. 2.

FIG. 6 is a schematic diagram of a beam information transmission method in the embodiments of a second aspect of the present disclosure, as shown in FIG. 6, the method includes:
operation 601, second request information is received, the second request information being used to indicate the terminal equipment to transmit at least the number and/or pattern parameter information of downlink received beams, and/or the number and/or or pattern parameter information of uplink transmitted beams; and
operation 602, the number and/or pattern parameter information of the downlink received beams, and/or the number and/or pattern parameter information of the uplink transmitted beams is(are) transmitted.

In the operation 601, the second request information is for example carried in a BeamInformEquiry message.

In the operation 602, in response to the received second request information, the terminal equipment 102 may transmit to the network device 101 at least the number and/or pattern parameter information of the downlink received beams and/or the number and/or pattern parameter information of uplink transmitted beams. For example, for a downlink channel, the terminal equipment 102 may transmit to the network device 101 at least the number and/or pattern parameter information of the downlink received beams; for an uplink channel, the terminal equipment 102 may transmit to the network device 101 at least the number and/or pattern parameter information of uplink transmitted beams.

In as least one embodiment in the operation 602, the number and/or pattern parameter information of the downlink received beams and/or the number and/or pattern parameter information of uplink transmitted beams may be carried in a BeamInformResponse message.

In as least one embodiment in the operation 602, the terminal equipment 102 may transmit at least the number and/or pattern parameter information of the downlink received beams and/or the number and/or pattern parameter information of uplink transmitted beams via at least one of Radio Resource Control (RRC) signaling, Media Access Control Control Element (MAC CE) or Uplink Control Information (UCI).

Through the embodiments of the second aspect, the terminal equipment 102 transmits at least the number and/or pattern parameter information of the downlink received beams and/or the number and/or pattern parameter information of the uplink transmitted beams to the network device 101, whereby the network device 101 is capable of training or selecting an appropriate model according to the number and/or pattern parameter information of the received downlink received beams and/or the number and/or pattern parameter information of the received uplink transmitted beams, so as to predict an optimal beam by using the model.

The pattern parameter information of the downlink received beams at least includes the number of beams of the downlink received beams in a first dimension and/or a second dimension. The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

For the description of the patterns of the downlink received beams, the description of the patterns of the uplink received beams in FIG. 5 may be referred to.

The pattern parameter information of the uplink transmitted beams at least includes the number of beams of the uplink transmitted beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

For the description of the patterns of the uplink transmitted beams, the description of the patterns of the downlink transmitted beams in FIG. 4 may be referred to.

### Embodiments of a Third Aspect

Embodiments of a third aspect provide a beam information reception method, applicable to a terminal equipment, such as the terminal equipment 102 in FIG. 1 or FIG. 2.

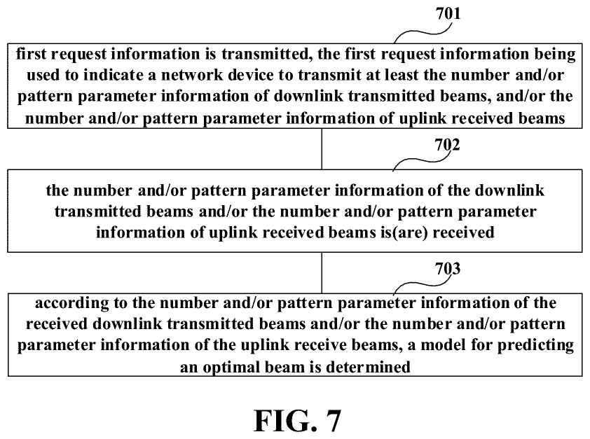

FIG. 7 is a schematic diagram of a beam information reception method in the embodiments of a third aspect of the present disclosure, as shown in FIG. 7, the method includes:
operation 701, first request information is transmitted, the first request information being used to indicate the network device to transmit at least the number and/or pattern parameter information of downlink transmitted beams, and/or the number and/or pattern parameter information of uplink received beams; and
operation 702, the number and/or pattern parameter information of the downlink transmitted beams and/or the number and/or pattern parameter information of uplink received beams is(are) receiving.

In the operation 701, the first request information is transmitted by for example being carried in a BeamInformEquiry message. The terminal equipment 102 may transmit the first request information for an uplink channel or a downlink channel. For example, for a downlink channel, the first request information is used to indicate the network device to transmit at least the number and/or pattern parameter information of downlink transmitted beams; for an uplink channel, the first request information is used to indicate the network device to transmit at least the number and/or pattern parameter information of uplink received beams.

In the operation 702, the terminal equipment 102 may receive at least the number and/or pattern parameter information of beams transmitted by the network device 101. For example, for a downlink channel, the terminal equipment 102 may receive at least the number and/or pattern parameter information of the downlink transmitted beams transmitted by the network device 101; for an uplink channel, the terminal equipment 102 may receive at least the number and/or pattern parameter information of uplink received beams transmitted by the network device 101.

In as least one embodiment in the operation 702, the number and/or pattern parameter information of the downlink transmitted beams and/or the number and/or pattern parameter information of uplink received beams may be carried in a BeamInformResponse message.

In as least one embodiment in the operation 702, the terminal equipment 102 may receive at least the number and/or pattern parameter information of the downlink transmitted beams and/or the number and/or pattern parameter information of uplink received beams via at least one of Radio Resource Control (RRC) signaling, Media Access Control Control Element (MAC CE) or Downlink Control Information (DCI).

Through the embodiments of the third aspect, the terminal equipment 102 may receive at least the number and/or pattern parameter information of the downlink transmitted beams and/or the number and/or pattern parameter information of the uplink received beams transmitted by the network device 101, whereby the terminal equipment 102 is capable of training or selecting an appropriate model according to the number and/or pattern parameter information of the received downlink transmitted beams and/or the number and/or pattern parameter information of the received uplink received beams, so as to predict an optimal beam by using the model.

As shown in FIG. 7, the beam information reception method further includes:
operation 703, according to the number and/or pattern parameter information of the received downlink transmitted beams and/or the number and/or pattern parameter information of the uplink received beams, a model for predicting an optimal beam is determined.

In at least one embodiment of the operation 703, the terminal equipment 102 may determine a model for predicting an optimal beam according to the number and/or pattern parameter information of the received downlink transmitted beams and the number and/or pattern parameter information of the downlink received beams known by the terminal equipment 102, for example determine a model through training, or select an appropriate model from a plurality of pre-stored models.

In at least another embodiment of the operation 703, the terminal equipment 102 may determine a model for predicting an optimal beam according to the number and/or pattern parameter information of the received uplink received beams and the number and/or pattern parameter information of the uplink transmitted beams known by the terminal equipment 102, for example determine a model through training, or select an appropriate model from a plurality of pre-stored models.

The pattern parameter information of the downlink transmitted beams at least includes the number of beams of the downlink transmitted beams in a first dimension and/or a second dimension.

The first dimension and the second dire dimension ction intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

The pattern parameter information of the uplink received beams includes the number of beams of the uplink received beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

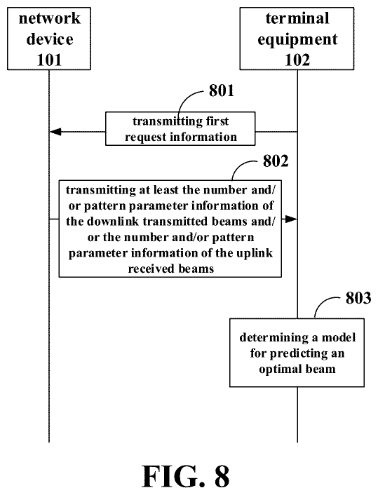

FIG. 8 is a flow schematic diagram in which a communication system of the present disclosure performs communication according to a beam information transmission method of the first aspect and a beam information reception method of the third aspect. As shown in FIG. 8, the process includes:
operation 801, the terminal equipment 102 transmits first request information to the network device 101; and
operation 802, the network device 101 transmits to the terminal equipment 102 at least the number and/or pattern parameter information of the downlink transmitted beams and/or the number and/or pattern parameter information of the uplink received beams.

The operation 801 and operation 802 in FIG. 8 correspond to the operation 701 and operation 702 in FIG. 7 respectively.

As shown in FIG. 8, the process may further include:
operation 803, according to the number and/or pattern parameter information of the received downlink transmitted beams and/or the number and/or pattern parameter information of the uplink received beams, the terminal equipment 102 determines a model for predicting an optimal beam.

The operation 803 corresponds to the 703 in FIG. 7.

In a case of determining a model for predicting an optimal beam, the terminal equipment 102 may predict the optimal beam by using the model.

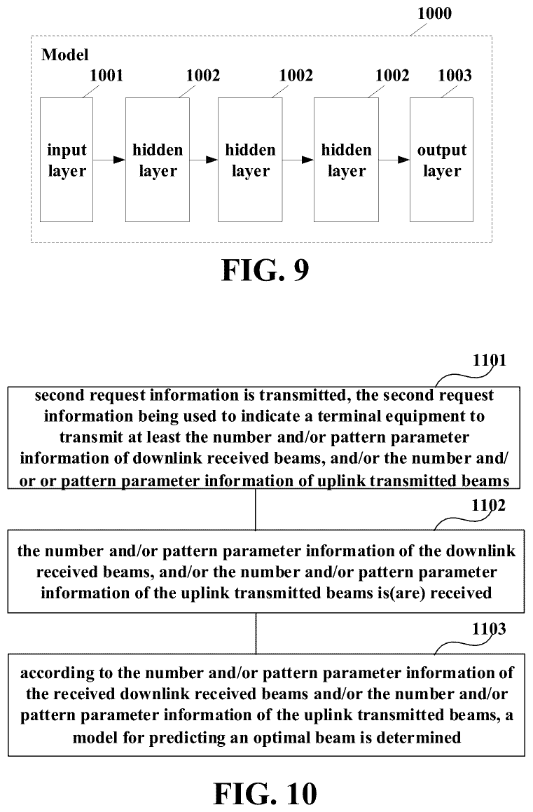

FIG. 9 is a schematic diagram of a model for predicting an optimal beam.

In the example of FIG. 9, it is assumed that the number of transmitted beams (the transmitted beams are uplink transmitted beams or downlink transmitted beams) is 12 and the number of received beams (the received beams are uplink received beams or downlink received beams) is 8, 96 beam pairs in total need to be measured. It is possible to only measure part of the beam pairs (for example, 24 beam pairs, of which 6 transmitted beams and 4 received beams), and a model 1000 is capable of predicting an optimal beam pair of all 96 beam pairs according to measurement results of such part of the beam pairs.

As shown in FIG. 9, the model 1000 may include an input layer 1001, a plurality of hidden layers 1002, and an output layer 1003.

The number of nodes of the input layer 1001 may be the same as the number of measured partial beam pairs; hence, the input layer 1001 is capable of receiving measurement results of the measured partial beam pairs. For example, the number of nodes of the input layer 1001 is 24, and the 24 nodes correspond to 24 measured beam pairs.

The number of nodes of the output layer 1003 may be the same as the number of all beam pairs, so that predicted values of all beam pairs may be output from the output layer 1003, that is, the model 1000 may be determined according to the number of the received beams and the number of the transmitted beams. For example, the number of nodes of the output layer 1003 is 96, corresponding to 96 beam pairs.

For example, the number of the hidden layers 1002 is 3, and each hidden layer 1002 may e.g. be a fully connected network. In addition, this embodiment is not limited to this, the hidden layer 1002 may be in other quantities, and moreover, each hidden layer 1002 may further be other types of networks. Parameters (such as the number of nodes, and a network structure) of each hidden layer 1002 may be related to the pattern information of the received beams and the pattern information of the transmitted beams.

In addition, the model 1000 may further select an optimal beam pair from the predicted results of 96 beam pairs.

It should be noted that the description of the model 1000 in FIG. 9 is only an example. As parameter information of the received beams and parameter information of the transmitted beams change, parameters of each layer in the model 1000 may change, and a specific structure of the model 1000 may also change.

### Embodiments of a Fourth Aspect

Embodiments of a fourth aspect provide a beam information reception method, applicable to a network device, such as the network device 101 in FIG. 1 or FIG. 2.

FIG. 10 is a schematic diagram of a beam information reception method in the embodiments of a fourth aspect of the present disclosure, as shown in FIG. 10, the method includes:
operation 1101, second request information is transmitted, the second request information being used to indicate a terminal equipment to transmit at least the number and/or pattern parameter information of downlink received beams, and/or the number and/or or pattern parameter information of uplink transmitted beams; and
operation 1102, the number and/or pattern parameter information of the downlink received beams, and/or the number and/or pattern parameter information of the uplink transmitted beams is(are) received.

In the operation 1101, the second request information is transmitted by for example being carried in a BeamInformEquiry message. The network device 101 may transmit the second request information for an uplink channel or a downlink channel. For example, for a downlink channel, the second request information is used to indicate a terminal equipment to transmit at least the number and/or pattern parameter information of downlink received beams; for an uplink channel, the second request information is used to indicate the terminal equipment to transmit at least the number and/or pattern parameter information of uplink transmitted beams.

In the operation 1102, the network device 101 may receive at least the number and/or pattern parameter information of beams transmitted by the terminal equipment 102. For example, for a downlink channel, the network device 101 may receive at least the number and/or pattern parameter information of the downlink received beams transmitted by the terminal equipment 102; for an uplink channel, the network device 101 may receive at least the number and/or pattern parameter information of uplink transmitted beams transmitted by the terminal equipment 102.

In as least one embodiment in the operation 1102, the number and/or pattern parameter information of the downlink received beams and/or the number and/or pattern parameter information of uplink transmitted beams may be carried in a BeamInformResponse message.

In as least one embodiment in the operation 1102, the network device 101 may receive at least the number and/or pattern parameter information of the downlink transmitted beams and/or the number and/or pattern parameter information of uplink received beams via at least one of Radio Resource Control (RRC) signaling, Media Access Control Control Element (MAC CE) or Uplink Control Information (UCI).

Through the embodiments of the fourth aspect, the network device 101 may receive at least the number and/or pattern parameter information of the downlink received beams and/or the number and/or pattern parameter information of the uplink transmitted beams transmitted by the terminal equipment 102, whereby the network device 101 is capable of training or selecting an appropriate model according to the number and/or pattern parameter information of the received downlink received beams and/or the number and/or pattern parameter information of the received uplink transmitted beams, so as to predict an optimal beam by using the model.

As shown in FIG. 10, the beam information reception method further includes:
operation 1103, according to the number and/or pattern parameter information of the received downlink received beams and/or the number and/or pattern parameter information of the uplink transmitted beams, a model for predicting an optimal beam is determined.

In at least one embodiment of the operation 1103, the network device 101 may determine a model for predicting an optimal beam according to the number and/or pattern parameter information of the received downlink received beams and the number and/or pattern parameter information of the downlink transmitted beams known by the network device 101, for example determine a model through training, or select an appropriate model from a plurality of pre-stored models.

In at least another embodiment of the operation 1103, the network device 101 may determine a model for predicting a beam measurement result according to the number and/or pattern parameter information of the received uplink transmitted beams and the number and/or pattern parameter information of the uplink received beams known by the network device 101, for example determine a model through training, or select an appropriate model from a plurality of pre-stored models.

The pattern parameter information of the downlink received beams includes the number of beams of the downlink received beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

The pattern parameter information of the uplink transmitted beams includes the number of beams of the uplink transmitted beams in a first dimension and/or a second dimension.

The first dimension and the second dimension intersect (that is, the first dimension and the second dimension are not parallel), for example, the first dimension and the second dimension are perpendicular. In one instance, the first dimension may be a horizontal dimension, and the second dimension may be a vertical dimension perpendicular to the horizontal dimension.

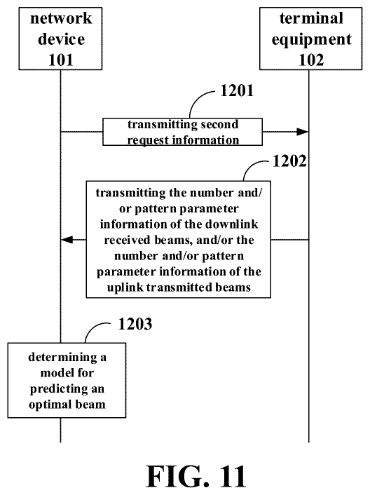

FIG. 11 is a flow schematic diagram in which a communication system of the present disclosure performs communication according to a beam information transmission method of the second aspect and a beam information reception method of the fourth aspect. As shown in FIG. 11, the process includes:
operation 1201, the network device 101 transmits second request information to the terminal equipment 102; and
operation 1202, the terminal equipment 102 transmits to the network device 101 the number and/or pattern parameter information of the downlink received beams, and/or the number and/or pattern parameter information of the uplink transmitted beams.

The operation 1201 and operation 1202 in FIG. 11 correspond to the operation 1101 and operation 1102 in FIG. 10 respectively.

As shown in FIG. 11, the process may further include:
operation 1203, according to the number and/or pattern parameter information of the received downlink received beams and/or the number and/or pattern parameter information of the uplink transmitted beams, the network device 101 determines a model for predicting an optimal beam.

The operation 1203 corresponds to the 1103 in FIG. 10.

In a case of determining a model for predicting a beam measurement result, the network device 101 may predict the beam measurement result by using model.

### Embodiments of a Fifth Aspect

The embodiments of a fifth aspect of the present disclosure provide a beam information transmission apparatus, applicable to a network device, corresponding to the beam information transmission method in the embodiments of the first aspect.

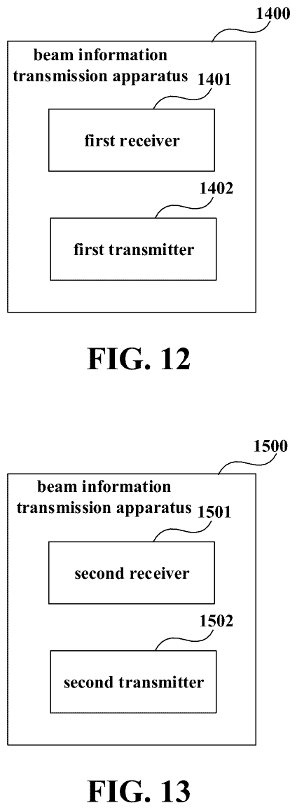

FIG. 12 is a schematic diagram of a beam information transmission apparatus in the embodiments of a fifth aspect, as shown in FIG. 12, a beam information transmission apparatus 1400 includes:
a first receiver 1401 receives first request information. The first request information being used to indicate the network device to transmit at least the number and/or pattern parameter information of downlink transmitted beams, and/or the number and/or pattern parameter information of uplink received beams; and a first transmitter 1402 configured to transmit at least the number and/or pattern parameter information of the downlink transmitted beams, and/or the number and/or pattern parameter information of uplink received beams.

The pattern parameter information of the downlink transmitted beams at least includes the number of beams of the downlink transmitted beams in a first dimension and/or a second dimension. The first dimension and the second dimension intersect.

The pattern parameter information of the uplink received beams at least includes the number of beams of the uplink received beams in a first dimension and/or a second dimension. The first dimension and the second dimension intersect.

In at least one embodiment, the number and/or pattern parameter information of the downlink transmitted beams and/or the number and/or pattern parameter information of the uplink received beams are transmitted via at least one of radio resource control (RRC) signaling, a media access control control element (MAC CE) or downlink control information (DCI).

### Embodiments of a Sixth Aspect

The embodiments of a sixth aspect of the present disclosure provide a beam information transmission apparatus, applicable to a terminal equipment, corresponding to the beam information transmission method in the embodiments of the second aspect.

FIG. 13 is a schematic diagram of a beam information transmission apparatus in the embodiments of a sixth aspect, as shown in FIG. 13, a beam information transmission apparatus 1500 includes:
a second receiver 1501 receives second request information, The second request information being used to indicate the terminal equipment to transmit at least the number and/or pattern parameter information of downlink received beams, and/or the number and/or or pattern parameter information of uplink transmitted beams; and
a second transmitter 1502 transmits at least the number and/or pattern parameter information of the downlink received beams, and/or the number and/or pattern parameter information of the uplink transmitted beams.

The pattern parameter information of the downlink received beams at least includes the number of beams of the downlink received beams in a first dimension and/or a second dimension. The first dimension and the dimension intersect.

The pattern parameter information of the uplink transmitted beams at least includes the number of beams of the uplink transmitted beams in a first dimension and/or a second dimension. The first dimension and the second dimension intersect.

In at least one embodiment, the number and/or pattern parameter information of the downlink received beams and/or the number and/or pattern parameter information of the uplink transmitted beams are transmitted via at least one of radio resource control (RRC) signaling, a media access control control element (MAC CE) or uplink control information (UCI).

### Embodiments of a Seventh Aspect

The embodiments of a seventh aspect of the present disclosure provide a beam information reception apparatus, applicable to a terminal equipment, corresponding to the beam information reception method in the embodiments of the third aspect.

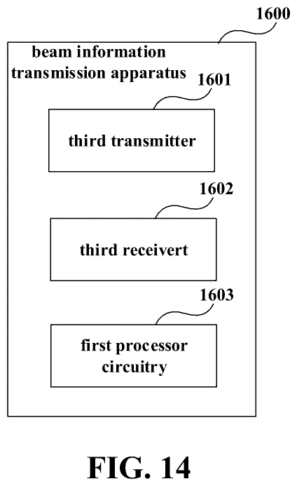

FIG. 14 is a schematic diagram of a beam information reception apparatus in the embodiments of a seventh aspect, as shown in FIG. 14, a beam information reception apparatus 1600 includes: a third transmitter 1601 transmits first request information. The first request information being used to indicate a network device to transmit at least the number and/or pattern parameter information of downlink transmitted beams, and/or the number and/or pattern parameter information of uplink received beams; and a third receiver 1602 receives at least the number and/or pattern parameter information of the downlink transmitted beams, and/or the number and/or pattern parameter information of the uplink received beams.

The pattern parameter information of the downlink transmitted beams at least includes the number of beams of the downlink transmitted beams in a first dimension and/or a second dimension. The first dimension and the second dimension intersect.

The pattern parameter information of the uplink received beams at least includes the number of beams of the uplink received beams in a first dimension and/or a second dimension. The first dimension and the second dimension intersect.

In at least one embodiment, the number and/or pattern parameter information of the downlink transmitted beams and/or the number and/or pattern parameter information of the uplink received beams are transmitted via at least one of radio resource control (RRC) signaling, a media access control control element (MAC CE) or downlink control information (DCI).

As shown in FIG. 14, the reception apparatus 1600 further includes:
a first processor circuitry 1603 configured to, according to the number and/or pattern parameter information of the downlink transmitted beams and/or the number and/or pattern parameter information of the uplink received beams, determine a model for predicting an optimal beam.

### Embodiments of an Eighth Aspect

The embodiments of an eighth aspect of the present disclosure provide a beam information reception apparatus, applicable to a network device, corresponding to the beam information reception method in the embodiments of the fourth aspect.

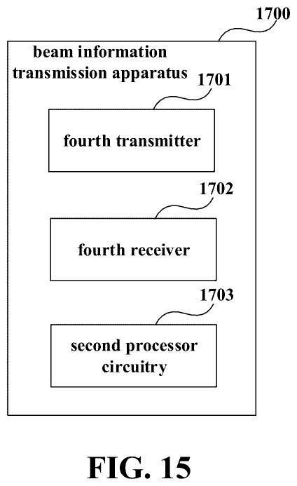

FIG. 15 is a schematic diagram of a beam information reception apparatus in the embodiments of an eighth aspect, as shown in FIG. 15, a beam information reception apparatus 1700 includes:
a fourth transmitter 1701 transmits second request information. The second request information being used to indicate a terminal equipment to transmit at least the number and/or pattern parameter information of downlink received beams, and/or the number and/or pattern parameter information of uplink transmitted beams; and
a fourth receiver 1702 receives the number and/or pattern parameter information of the downlink received beams, and/or the number and/or pattern parameter information of the uplink transmitted beams.

The pattern parameter information of the downlink received beams at least includes the number of beams of the downlink received beams in a first dimension and/or a second dimension. The first dimension and the second dimension intersect.

The pattern parameter information of the uplink transmitted beams at least includes the number of beams of the uplink transmitted beams in a first dimension and/or a second dimension. The first dimension and the second dimension intersect.

In at least one embodiment, the number and/or pattern parameter information of the downlink received beams and/or the number and/or pattern parameter information of the uplink transmitted beams are transmitted via at least one of radio resource control (RRC) signaling, a media access control control element (MAC CE) or uplink control information (UCI).

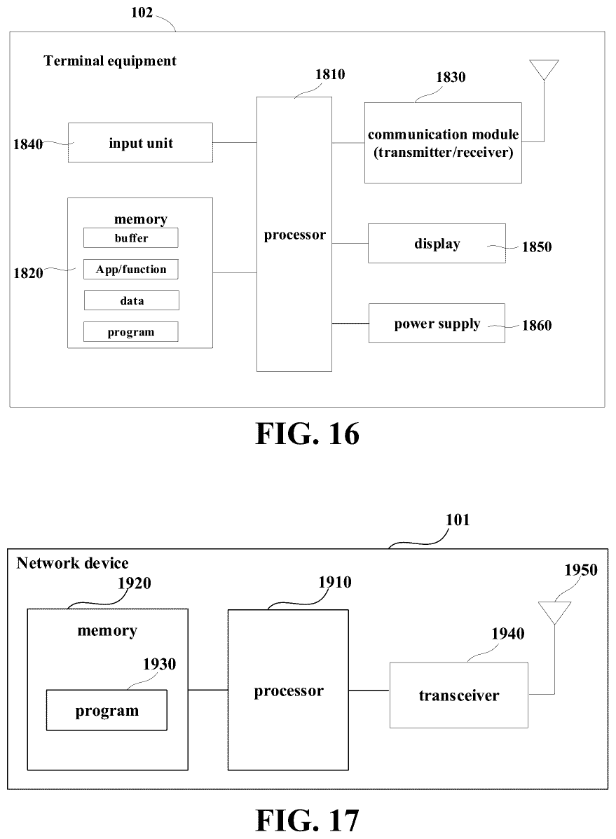

As shown in FIG. 16, the reception apparatus 1700 further includes:
a second processor circuitry 1703 configured to, according to the number and/or pattern parameter information of the downlink received beams and/or the number and/or pattern parameter information of the uplink transmitted beams, determine a model for predicting an optimal beam.

### Embodiments of a Ninth Aspect

The embodiments of a ninth aspect of the present disclosure provide a communication system, the communication system may include a network device and a terminal equipment.

FIG. 16 is a schematic diagram of a terminal equipment in the embodiments of a ninth aspect. As shown in FIG. 16, a terminal equipment 102 may include a processor 1810 and a memory 1820; the memory 1820 stores data and programs, and is coupled to the processor 1810. It's worth noting that this figure is exemplary; other types of structures can also be used to supplement or replace this structure, so as to realize a telecommunication function or other functions.

For example, the processor 1810 may be configured to execute a program to implement the method described in the embodiments of the second aspect and/or the third aspect.

As shown in FIG. 16, the terminal equipment 102 may further include: a communication module 1830, an input unit 1840, a display 1850 and a power supply 1860. The functions of said components are similar to relevant arts, which are not repeated here. It's worth noting that the terminal equipment 102 does not have to include all the components shown in FIG. 16, said components are not indispensable. Moreover, the terminal equipment 102 may also include components not shown in FIG. 16, relevant arts can be referred to.

FIG. 17 is a schematic diagram of a network device in the embodiments of a ninth aspect. As shown in FIG. 17, a network device 101 may include: a processor 1910 (such as a central processing unit (CPU)) and a memory 1920; the memory 1920 is coupled to the processor 1910. The memory 1920 may store various data; moreover, also stores a program 1930 for information processing, and executes the program 1930 under the control of the processor 1910.

For example, the processor 1910 may be configured to execute a program to implement the method described in the embodiments of the first aspect and/or the fourth aspect.

In addition, as shown in FIG. 17, the network device 101 may further include: a transceiver 1940 and an antenna 1950, etc., wherein the functions of said components are similar to relevant arts, which are not repeated here. It's worth noting that the network device 101 does not have to include all the components shown in FIG. 17. Moreover, the network device 101 may also include components not shown in FIG. 17, relevant arts can be referred to.

The embodiments of the present disclosure further provide a computer program, wherein when a terminal equipment executes the program, the program enables the terminal equipment to execute the method described in the embodiments of the second aspect and/or the third aspect.

The embodiments of the present disclosure further provide a storage medium in which a computer program is stored, wherein the computer program enables a terminal equipment to execute the method described in the embodiments of the second aspect and/or the third aspect.

The embodiments of the present disclosure further provide a computer program, wherein when a network device executes the program, the program enables the network device to execute the method described in the embodiments of the first aspect and/or the fourth aspect.

The embodiments of the present disclosure further provide a storage medium in which a computer program is stored, wherein the computer program enables a network device to execute the method described in the embodiments of the first aspect and/or the fourth aspect.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module can be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the drawings can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the spirit and principle of the present disclosure, these variations and modifications are also within the scope of the present disclosure.

As for the implementations including the above embodiments, the following supplements are further disclosed:

1. A beam information transmission method, applicable to a network device, the method including:
receiving first request information, the first request information being used to indicate the network device to transmit at least the number and/or pattern parameter information of downlink transmitted beams and/or the number and/or pattern parameter information of uplink received beams; and
transmitting the number and/or pattern parameter information of the downlink transmitted beams and/or the number and/or pattern parameter information of uplink received beams.

2. The method according to Supplement 1, wherein,
the pattern parameter information of the downlink transmitted beams at least includes:
the number of beams of the downlink transmitted beams in a first dimension and/or a dimension;
the first dimension and the second dimension intersecting.

3. The method according to Supplement 1, wherein,
the pattern parameter information of the uplink received beams at least includes:
the number of beams of the uplink received beams in a first dimension and/or a second dimension,
the first dimension and the second dimension intersecting.

4. The method according to Supplement 1, wherein,
the number and/or pattern parameter information of the downlink transmitted beams and/or the number and/or pattern parameter information of the uplink received beams are transmitted via at least one of radio resource control (RRC) signaling, a media access control control element (MAC CE) or downlink control information (DCI).

5. A beam information transmission method, applicable to a terminal equipment, the method including:
receiving second request information, the second request information being used to indicate the terminal equipment to transmit at least the number and/or pattern parameter information of downlink received beams, and/or the number and/or or pattern parameter information of uplink transmitted beams; and
transmitting the number and/or pattern parameter information of the downlink received beams, and/or the number and/or pattern parameter information of the uplink transmitted beams.

6. The method according to Supplement 5, wherein,
the pattern parameter information of the downlink received beams at least includes:
the number of beams of the downlink received beams in a first dimension and/or a second dimension, the first dimension and the second dimension intersecting.

7. The method according to Supplement 5, wherein,
the pattern parameter information of the uplink transmitted beams at least includes:
the number of beams of the uplink transmitted beams in a first dimension and/or a second dimension,
the first dimension and the second dimension intersecting.

8. The method according to Supplement 5, wherein,
the number and/or pattern parameter information of the downlink received beams and/or the number and/or pattern parameter information of the uplink transmitted beams are transmitted via at least one of radio resource control (RRC) signaling, a media access control control element (MAC CE) or uplink control information (UCI).

9. A beam information reception method, applicable to a terminal equipment, the method including:
transmitting first request information, the first request information being used to indicate a network device to transmit at least the number and/or pattern parameter information of downlink transmitted beams, and/or the number and/or pattern parameter information of uplink received beams; and
receiving the number and/or pattern parameter information of the downlink transmitted beams, and/or the number and/or pattern parameter information of uplink received beams.

10. The method according to Supplement 9, wherein,
the pattern parameter information of the downlink transmitted beams at least includes:
the number of beams of the downlink transmitted beams in a first dimension and/or a second dimension,
the first dimension and the second dimension intersecting.

11. The method according to Supplement 9, wherein,
the pattern parameter information of the uplink received beams at least includes:
the number of beams of the uplink received beams in a first dimension and/or a second dimension,
the first dimension and the second dimension intersecting.

12. The method according to Supplement 9, wherein,
the number and/or pattern parameter information of the downlink transmitted beams and/or the number and/or pattern parameter information of the uplink received beams are received via at least one of radio resource control (RRC) signaling, a media access control control element (MAC CE) or downlink control information (DCI).

13. The method according to Supplement 9, wherein,
the method further includes:
according to the number and/or pattern parameter information of the downlink transmitted beams and/or the number and/or pattern parameter information of the uplink received beams, determining a model for predicting an optimal beam.

14. A beam information reception method, applicable to a network device, the method including:
transmitting second request information, the second request information being used to indicate a terminal equipment to transmit at least the number and/or pattern parameter information of downlink received beams, and/or the number and/or or pattern parameter information of uplink transmitted beams; and
receiving the number and/or pattern parameter information of the downlink received beams, and/or the number and/or pattern parameter information of the uplink transmitted beams.

15. The method according to Supplement 14, wherein,
the pattern parameter information of the downlink received beams at least includes:
the number of beams of the downlink received beams in a first dimension and/or a second dimension,
the first dimension and the second dimension intersecting.

16. The method according to Supplement 14, wherein,
the pattern parameter information of the uplink transmitted beams at least includes:
the number of beams of the uplink transmitted beams in a first dimension and/or a second dimension,
the first dimension and the second dimension intersecting.

17. The method according to Supplement 14, wherein,
the number and/or pattern parameter information of the downlink received beams and/or the number and/or pattern parameter information of the uplink transmitted beams are received via at least one of radio resource control (RRC) signaling, a media access control control element (MAC CE) or uplink control information (UCI).

18. The method according to Supplement 14, wherein,
the method further includes:
according to the number and/or pattern parameter information of the downlink received beams and/or the number and/or pattern parameter information of the uplink transmitted beams, determining a model for predicting an optimal beam.

What is claimed is:

1. A beam information transmission apparatus, applicable to a network device, the apparatus comprising:
a first receiver receives first request information. The first request information being used to indicate the network device to transmit at least the number and/or pattern parameter information of downlink transmitted beams and/or the number and/or pattern parameter information of uplink received beams; and
a first transmitter transmits at least the number and/or pattern parameter information of the downlink transmitted beams, and/or the number and pattern parameter information of uplink received beams.

2. The apparatus according to claim 1, wherein,
the pattern parameter information of the downlink transmitted beams at least comprises:
the number of beams of the downlink transmitted beams in a first dimension and/or a second dimension,
the first dimension and the second dimension intersecting.

3. The apparatus according to claim 1, wherein,
the pattern parameter information of the uplink received beams at least comprises:
the number of beams of the uplink received beams in a first dimension and/or a second dimension,
the first dimension and the second dimension intersecting.

4. The apparatus according to claim 1, wherein,
the number and/or pattern parameter information of the downlink transmitted beams and/or the number and/or pattern parameter information of the uplink received beams are transmitted via at least one of radio resource control (RRC) signaling, a media access control control element (MAC CE) or downlink control information (DCI).

5. A beam information transmission apparatus, applicable to a terminal equipment,
the apparatus comprising:
a second receiver receives second request information, the second request information being used to indicate the terminal equipment to transmit at least the number and/or pattern parameter information of downlink received beams, and/or the number and/or pattern parameter information of uplink transmitted beams; and
a second transmitter transmits at least the number and/or pattern parameter information of the downlink received beams, and/or the number and/or pattern parameter information of the uplink transmitted beams,
and/or,
the apparatus comprising:
a third transmitter transmits first request information, the first request information being used to indicate a network device to transmit at least the number and/or pattern parameter information of downlink transmitted beams, and/or the number and/or pattern parameter information of uplink received beams; and
a third receiver receives at least the number and/or pattern parameter information of the downlink transmitted beams, and/or the number and/or pattern parameter information of the uplink received beams.

6. The apparatus according to claim 5, wherein,
the pattern parameter information of the downlink received beams at least comprises:
the number of beams of the downlink received beams in a first dimension and/or a second dimension,
the first dimension and the second dimension intersecting.

7. The apparatus according to claim 5, wherein,
the pattern parameter information of the uplink transmitted beams at least comprises:
the number of beams of the uplink transmitted beams in a first dimension and/or a second dimension,
the first dimension and the second dimension intersecting.

8. The apparatus according to claim 5, wherein,
the number and/or pattern parameter information of the downlink received beams and/or the number and/or pattern parameter information of the uplink transmitted beams are transmitted via at least one of radio resource control (RRC) signaling, a media access control control element (MAC CE) or uplink control information (UCI).

9. The apparatus according to claim 5, wherein,
the pattern parameter information of the downlink transmitted beams at least comprises:
the number of beams of the downlink transmitted beams in a first dimension and/or a second dimension,
the first dimension and the second dimension intersecting.

10. The apparatus according to claim 5, wherein,
the pattern parameter information of the uplink received beams at least comprises:
the number of beams of the uplink received beams in a first dimension and/or a second dimension,
the first dimension and the second dimension intersecting.

11. The apparatus according to claim 5, wherein,
the number and/or pattern parameter information of the downlink transmitted beams and/or the number and/or pattern parameter information of the uplink received beams are received via at least one of radio resource control (RRC) signaling, a media access control control element (MAC CE) or downlink control information (DCI).

12. The apparatus according to claim 5,
the apparatus further comprising:
first processor circuitry configured to, according to the number and/or pattern parameter information of the downlink transmitted beams and/or the number and/or pattern parameter information of the uplink received beams, determine a model for predicting an optimal beam.

13. A beam information reception apparatus, applicable to a network device, the apparatus comprising:
a fourth transmitter transmits second request information. The second request information being used to indicate a terminal equipment to transmit at least the number and/or pattern parameter information of downlink received beams, and/or the number and/or pattern parameter information of uplink transmitted beams; and
a fourth receiver receives at least the number and/or pattern parameter information of the downlink received beams and/or the number and/or pattern parameter information of the uplink transmitted beams.

14. The apparatus according to claim 13, wherein,
the pattern parameter information of the downlink received beams at least comprises:
the number of beams of the downlink received beams in a first dimension and/or a second dimension,
the first dimension and the second dimension intersecting.

15. The apparatus according to claim 13, wherein,
the pattern parameter information of the uplink transmitted beams at least comprises:
the number of beams of the uplink transmitted beams in a first dimension and/or a second dimension,
the first dimension and the second dimension intersecting.

16. The apparatus according to claim 13, wherein,
the number and/or pattern parameter information of the downlink received beams and/or the number and/or pattern parameter information of the uplink transmitted beams are received via at least one of radio resource control (RRC) signaling, a media access control control element (MAC CE) or uplink control information (UCI).

17. The apparatus according to claim 13,
the apparatus further comprising:
second processor circuitry configured to, according to the number and/or pattern parameter information of the downlink received beams and/or the number and/or pattern parameter information of the uplink transmitted beams, determine a model for predicting an optimal beam.
